(19) United States
(12) Patent Application Publication
(10) Pub. No.: US 2013/0285584 A1
(43) Pub. Date: Oct. 31, 2013

(54) MOTOR DRIVING APPARATUS AND METHOD

(71) Applicants: Han Tae Kim, Gyunggi-do (KR); Changsung Sean Kim, Gyunggi-do (KR); Guen Hong Lee, Gyunggi-do (KR); Chang Hwan Choi, Gyunggi-do (KR); Han Kyung Bae, Gyunggi-do (KR)

(72) Inventors: Han Tae Kim, Gyunggi-do (KR); Changsung Sean Kim, Gyunggi-do (KR); Guen Hong Lee, Gyunggi-do (KR); Chang Hwan Choi, Gyunggi-do (KR); Han Kyung Bae, Gyunggi-do (KR)

(73) Assignee: SAMSUNG ELECTRO-MECHANICS CO., LTD., Gyunggi-do (KR)

(21) Appl. No.: 13/558,275

(22) Filed: Jul. 25, 2012

(30) Foreign Application Priority Data
Apr. 27, 2012 (KR) 10-2012-0044567

(51) Int. Cl. H02P 6/12

(52) U.S. Cl. 318/400.21

(57) ABSTRACT

Disclosed herein are a motor driving apparatus and method. The motor driving apparatus includes: an inverter including a main driver sequentially activating N phases and a spare driver activating a spare phase substituting for a faulted phase among the activated N phases; a detecting unit detecting the respective output signals of the N phases; a switching unit performing switching so that the spare phase is connected to the faulted phase of the exited N phases; and a controlling unit driving the inverter to determine whether or not a fault is generated and control the switching unit so that the faulted phase is connected to the spare phase. Therefore, since the motor may be driven without replacing the inverter, a cost may be reduced, and since the motor may be driven without a change in the number of phases, the motor may be efficiently and stably driven.

### CROSS REFERENCE TO RELATED APPLICATION

This application claims the benefit of Korean Patent Application No. 10-2012-0044567, filed on Apr. 27, 2012, entitled “A Driving Apparatus and Method Of Motor”, which is hereby incorporated by reference in its entirety into this application.

### BACKGROUND OF THE INVENTION

1. Technical Field

The present invention relates to a motor driving apparatus and method.

2. Description of the Related Art

Generally, a motor has been widely used in various fields of industrial facilities in order to transfer power. Recently, as the demand for a technology capable of accurately controlling various process facilities increases, the necessity of research into a technology for immediately diagnosing abnormality of a phase driving a single-phase or a multi-phase motor at the time of driving of the motor to efficiently and stably drive the motor has also increased.

In a motor driving apparatus and method according to the prior art disclosed in Korean Patent No. 10-0360247, whether or not a fault is generated in a corresponding phase according to a current value measured by applying current to coils of each of three phases at the time of driving of a three-phase motor is determined.

Then, in the case in which a fault is detected in any one of three phases, a corresponding switch device is turned off so as to break current flowing in a coil of a corresponding phase according to a control output signal transmitted from a microcomputer, thereby preventing degradation or damage of the motor.

However, in the case of the motor driving apparatus and method according to the prior art as described above, since the motor is driven with phases except for the faulted phase, a driving method becomes complicated and the number of phases driving the motor is reduced, such that the motor is inefficiently and unstably driven. Therefore, reliability of the motor may be deteriorated. Further, in some cases, since the entire driving part driving the motor should be replaced, an increase in a cost may occur.

### PRIOR ART DOCUMENT

### Patent Document

(Patent Document 1) Korean Patent No. 10-0360247

### SUMMARY OF THE INVENTION

The present invention has been made in an effort to provide a motor driving apparatus and method capable of being driven without changing the number of phases by installing a spare phase in an inverter driven with N phases and replacing a faulted phase with the space phase when a fault is generated in any one of the N phases.

According to a preferred embodiment of the present invention, there is provided a motor driving apparatus including: an inverter including a main driver sequentially activating N phases of a motor and a spare driver activating a spare phase substituting for a faulted phase among the activated N phases; a detecting unit detecting the respective output signals of the N phases input from the inverter to the motor; a switching unit performing switching so that the spare phase of the spare driver is connected to the faulted phase of the exited N phases; and a controlling unit driving the inverter to determine whether or not a fault is generated in the phase of the main driver from the respective detected output signals of the N phases and control the switching unit so that the faulted phase is connected to the spare phase when the fault is generated in the phase.

The inverter may further include a power supply unit supplying power to the main driver and the spare drive.

The motor may be a switched reluctance motor (SRM).

The main driver of the inverter may include: N coils corresponding to the N phases designed in the motor and having upper terminals and lower terminals to and from which current is input and output; N pairs of switch devices including upper switch devices and lower switch devices that are connected in series with the upper terminals and the lower terminals of the N coils, respectively; and N pairs of diodes including upper diodes each connected in parallel with the upper switch devices and lower diodes each connected in parallel with the lower switch devices so that winding current of a corresponding coil is circulated when any one of the N pairs of switch devices is turned off.

The spare driver of the inverter may include: an upper spare terminal and a lower spare terminal corresponding to a corresponding coil of the phase of the main driver corresponding to the faulted phase among the N phases designed in the motor; at least one pair of spare switch devices including an upper spare switch device and a lower spare switch device each connected in series with the upper spare terminal and the lower spare terminal; and at least one pair of spare diodes including an upper spare diode connected in parallel with the upper spare switch device and a lower spare diode connected in parallel with the lower spare switch device so that the winding current of the corresponding coil is circulated when any one of the at least one pair of spare switch devices is turned off.

The switching unit may include: N upper switches each having one end connected to the upper spare terminal and the other end connected to the respective upper terminals of the N coils to perform switching so that the upper spare terminal is connected to any one of the upper terminals of the N coils according to a switching control signal input from the controlling unit; and N lower switches each having one end connected to the lower spare terminal and the other end connected to the respective lower terminals of the N coils to perform switching so that the lower spare terminal is connected to any one of the lower terminals of the N coils according to the switching control signal.

The controlling unit may control the corresponding upper switch so that the upper spare terminal of the spare driver is connected to the upper terminals of the corresponding coils of the main driver and at the same time, control the corresponding lower switch so that the lower spare terminal of the spare driver is connected to the lower terminals of the corresponding coils of the main driver, in order to connect the corresponding coil of the main driver corresponding to the faulted phase among the N phases to the spare driver.

The motor may be a permanet synchronous motor (PMSM).

The main driver of the inverter may include: N coils corresponding to the N phases designed in the motor, having one connection point at which each of the N coils is connected to each other and common terminals to and from which current is input and output, and installed between the connection point and the respective common terminals; and N pairs of switch devices including upper switch devices and lower switch devices that are connected in series with upper and lower ends of the common terminals of the N coils.

The spare driver of the inverter may include: a common spare terminal corresponding to a corresponding coil of the phase of the main driver corresponding to the faulted phase among the N phases designed in the motor; and at least one pair of spare switch devices including an upper spare switch device and a lower spare switch device each connected in series with upper and lower ends of the common spare terminal.

The switching unit may include N switches each having one end connected to the common spare terminal and the other end connected to each of the common terminals of the N coils to perform switching so that the common spare terminal is connected to any one of the common terminals of the N coils according to a switching control signal input from the controlling unit.

The controlling unit may control the corresponding switch so that the common spare terminal of the spare driver is connected to the common terminals of the corresponding coils of the main driver, in order to connect the corresponding coil of the main driver corresponding to the faulted phase among the N phases to the spare driver.

The detecting unit may be a current sensor, a voltage sensor, a phase position sensor, or a combination thereof.

The detected signal may be a current signal, a voltage signal, a phase position signal, or a combination thereof.

According to another preferred embodiment of the present invention, there is provided a motor driving method including: (A) driving a main driver of an inverter to sequentially activate N phases designed in a motor; (B) detecting, in a detecting unit, the respective output signals of the activated N phases of the main driver input from the inverter to the motor; and (C) determining, in a controlling unit, whether or not a fault is generated in the phase of the main driver from the respective detected output signals of the N phases and performing switching so that the faulted phase is connected to a spare driver of the inverter substituting for the faulted phase when the fault is generated in the phase.

Step (C) may include: (C) determining, in the controlling unit, whether or not the fault is generated in the phase of the main driver from the respective detected output signals of the N phases; and (C2) performing, in the controlling unit, switching so that the faulted phase of the main driver is connected to a spare phase of the spare driver substituting for the faulted phase when the fault is generated in the phase of the main driver.

Step (C1) may include: (C1-1) determining, in the controlling unit, whether the respective detected output signals of the N phases are a set value (A); (C1-2) determining that the fault is generated in the corresponding phase in the case in which the respective detected output signals of the N phases are the set value A, wherein the respective output signals of the N phases are current signals and the set value A is 0 mA.

Step (C1) may further include, after step (C1-1), (C1-3) waiting for a set time (B) and then re-detecting the respective re-output signals of the N phases in the case in which the respective output signals of the N phases are the set value (A); (C1-4) determining whether the respective re-detected re-output signals of the N phases are the set value (A); and (C1-5) determining that the fault is generated in a corresponding phase in the case in which the respective re-detected re-output signals of the N phases are the set value (A), wherein the respective output signals and re-output signals of the N phases are current signals, the set value (A) is 0 mA, and the set time (B) is 15 to 25 seconds.

Step (C1-1) may include determining that a corresponding phase is normal in the case in which the respective output signals of the N phases are not the set value (A).

Step (C1-4) may include determining that a corresponding phase is normal in the case in which the respective re-detected signals of the N phases are not the set value (A).

Step (C2) may include: (C2-1) providing, in the controlling unit, a switching control signal to a switching unit configured to connect between a terminal of a coil corresponding to the faulted phase and a spare terminal corresponding to the spare phase of the spare driver when the fault is generated in the phase of the main driver; and (C2-2) performing, in the switching unit, switching so that the terminal of the coil corresponding to the faulted phase of the main driver is connected to the spare terminal according to the switching control signal provided from the controlling unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a motor driving apparatus according to a preferred embodiment of the present invention;

FIG. 2 is a circuit diagram according to a first example of the motor driving apparatus shown in FIG. 1;

FIG. 3 is a circuit diagram according to a second example of the motor driving apparatus shown in FIG. 1;

FIG. 4 is a flow chart showing a motor driving method according to the preferred embodiment of the present invention; and

FIG. 5 is a partial detailed flow chart of the motor driving method shown in FIG. 4.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

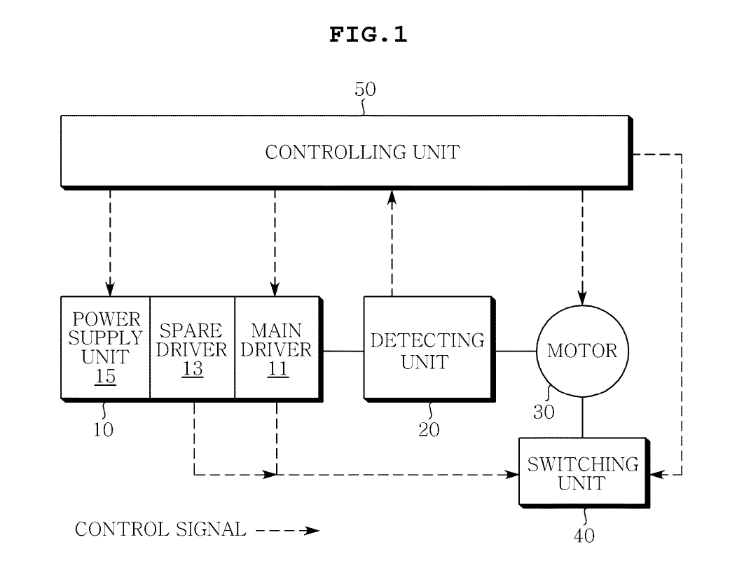

FIG. 1 is a block diagram of a motor driving apparatus according to a preferred embodiment of the present invention.

Referring to FIG. 1, the motor driving apparatus according to the preferred embodiment of the present invention is configured to include an inverter 10, a detecting unit 20, a motor 30, a switching unit 40, and a controlling unit 50.

The inverter 10, which is to drive the motor 30, includes a main driver 11 sequentially activating N phases designed in the motor 30 so that a positive torque is generated in a rotor positioned at an inner side of a stator of the motor 30 to thereby rotate, a spare driver 13 activating a spare phase substituting for a phase of the main driver 11 corresponding to a faulted phase among the N phases activated by the main driver 11, and a power supply unit 15 supplying power to the main driver 11 and the spare driver 13.

Here, the ‘spare phase’, which is a phase additionally installed in addition to the N phases designed in the motor 30, means an extra phase substituting for a faulted phase when a fault is generated in any one of the N phases driving the motor 30 to allow the motor to be normally driven with the N phases rather than, for example, N−1 phases at the time of driving thereof.

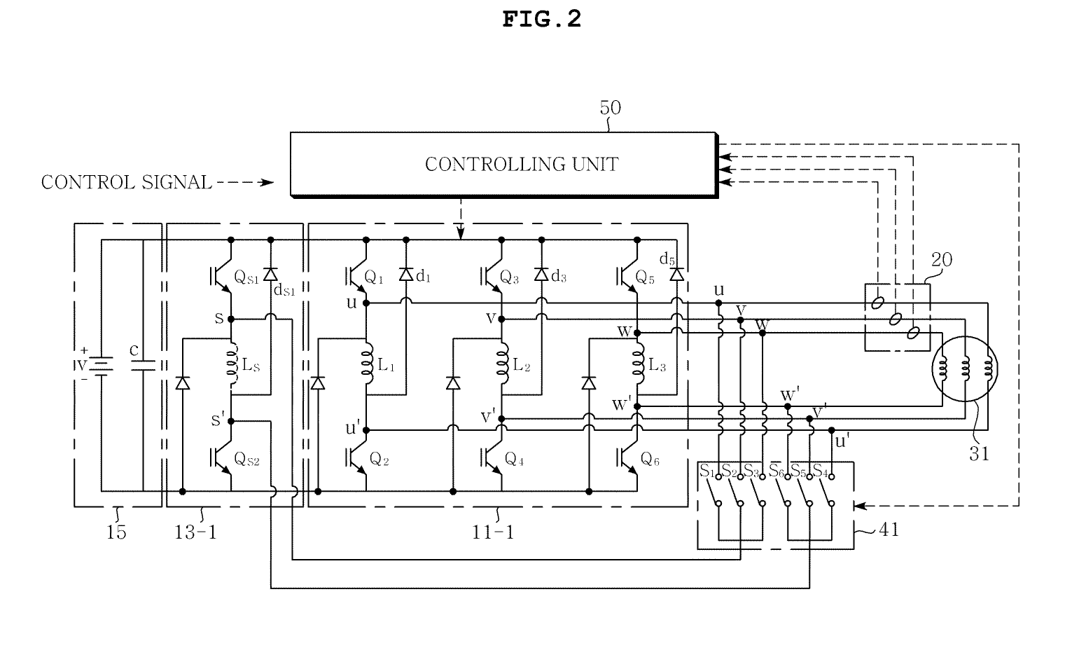

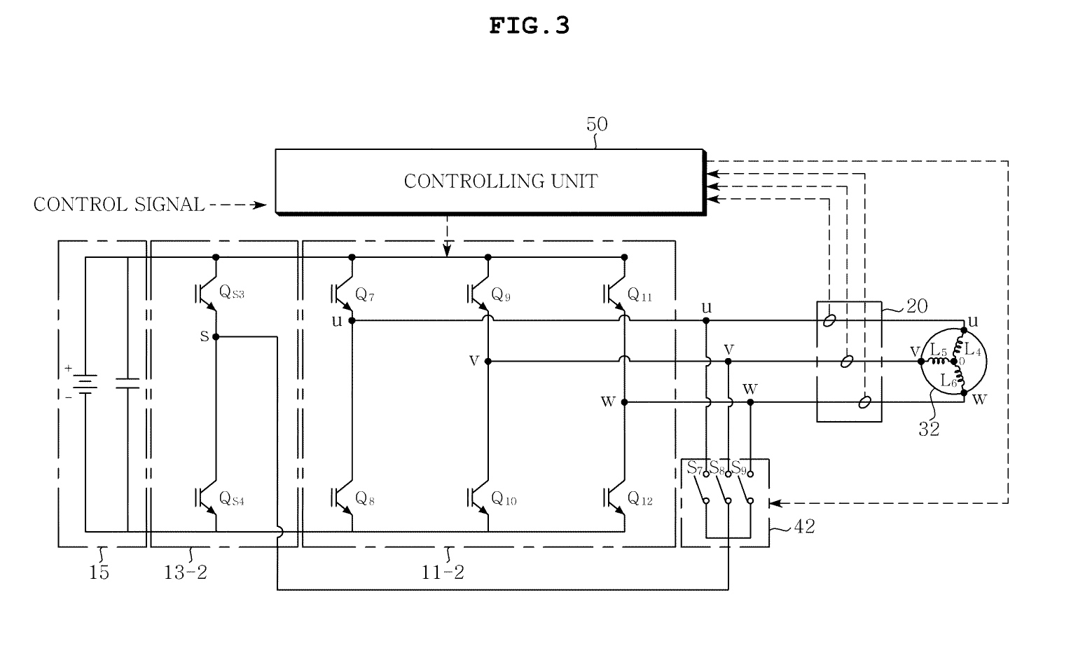

Detailed configurations of circuits of the main driver 11 and the spare driver 13 of the inverter 10 may be changed according to a kind of motor 30, which will be described below in detail with reference to FIGS. 2 and 3.

The power supply unit 15 of the inverter 10 includes a source power supply connected in parallel with the main driver 11 and the spare driver 13 and a capacitor C connected in parallel with the source power supply to smooth and output source power supply voltage Vs.

The detecting unit 20 is installed between the motor 30 and the inverter 10 to detect output signals of each of the N phases input from the inverter 10 to the motor 30.

The detecting unit 20 may include a current sensor, a voltage sensor, a phase position sensor, or a combination thereof. Therefore, the output signals of each of the N phases may include, for example, a current signal, a voltage signal, a phase position signal, or a combination thereof.

The switching unit 40 is installed between the main driver 11 and the spare driver 13 and receives a switching control signal from the controlling unit 50 when a fault is generated in the activated N phases of the main driver 11 to perform switching so that the faulted phase of the main driver 11 is connected to the spare phase of the spare driver 13.

The controlling unit 50, which generally controls the motor driving apparatus according to the preferred embodiment of the present invention, drives the inverter 10 to sequentially activate the N phases, receives the output signals of each of the activated N phases detected from the detecting unit 20 to determine whether or not a fault is generated in a phase of the main driver 11, and controls the switching unit 40 so that a faulted phase is connected to the spare phase of the spare driver 13 when the fault is generated in the phase of the main driver 11.

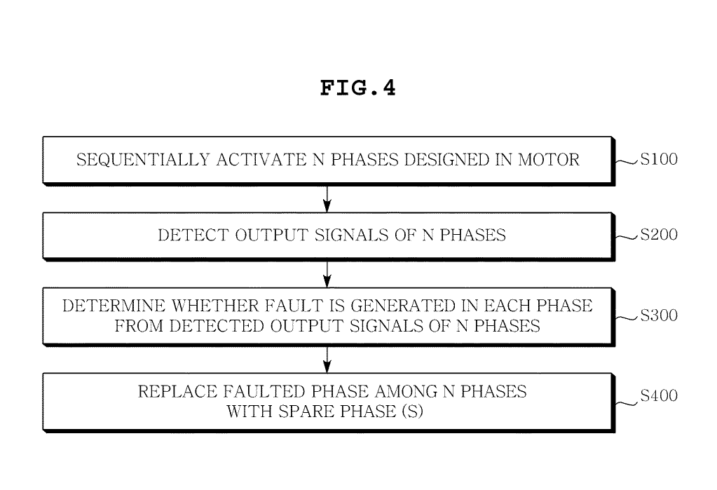

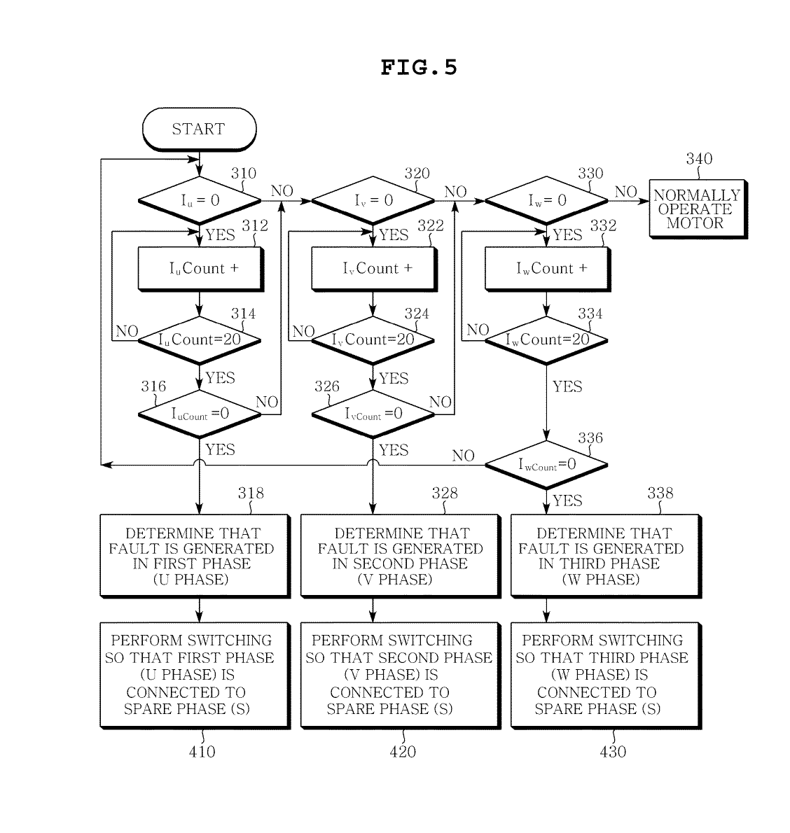

The motor driving method of the controlling unit 50 will be described below in detail with reference to FIGS. 4 and 5.

Meanwhile, as described above, the motor driving apparatus shown in FIG. 1 according to a kind of motor 30 will be described in detail.

FIG. 2 is a circuit diagram according to a first example of the motor driving apparatus shown in FIG. 1.

As shown in FIG. 2, in the present embodiment, a switched reluctance motor (SRM) 31 is used as the motor 30.

In the case in which the SRM 31 is used, the main driver 11-1 of the inverter 10 includes N coils L₁, L₂, and L₃, corresponding to the N phases designed in the SRM 31 and having upper terminals u, v, and w and lower terminals u′, v′, and w′ to and from which current is input and output and N pairs of switch devices including upper switch devices Q₁, Q₃, and Q₅ and lower switch devices Q₂, Q₄, and Q₆ that are connected in series with the upper terminals u, v, and w and the lower terminals u′, v′, and w′ of the N coils L₁, L₂, and L₃, respectively.

In addition, the main driver 11-1 of the inverter 10 includes N pairs of diodes including upper diodes d₁, d₃, and d₅ each connected in parallel with the upper switch devices Q₁, Q₃, and Q₅ and lower diodes d₂, d₄, and d₆ each connected in parallel with the lower switch devices Q₂, Q₄, and Q₆ so that winding current of a corresponding coil L₁, L₂, or L₃ is circulated when any one of the N pairs of switch devices Q₁ to Q₆ is turned off.

The main driver 11-1 of the inverter 10 of the SRM 31 configured as described above sequentially activate the N coils L₁, L₂, and L₃ corresponding to the N phases so that a positive torque is generated in the rotor positioned at the inner side of the stator of the SRM 31 to thereby rotate.

To this end, the inverter 10 according to the present embodiment may have four modes (mode 1 to mode 4).

In mode 1 in which the inverter 10 is driven, both of corresponding upper and lower switch devices Q₁ and Q₂ of a coil L₁ corresponding to a corresponding phase (for example, a first phase (a U phase)) that is intended to be activated are turned on. Therefore, the entire source power supply voltage Vs is applied to the corresponding coil L₁, such that the winding current flows therein.

Next, in mode 2 in which the inverter 10 is driven, both of the corresponding switch devices Q₁ and Q₂ of the corresponding coil (for example, L₁) that is not intended to be activated are turned off, and the winding current is reduced by returning energy to the capacitor C through the upper and lower diodes d₁ and d₂.

In this case, the current needs to be completely removed or an amount of the current needs to be significantly small, before inductance of the corresponding phase (for example, the first phase (the U phase) has a negative slope. In mode 2, voltage applied to the corresponding coil L₁ is negative source power supply voltage (−Vs).

In addition, in mode 3 in which the inverter 10 is driven, only the upper switch device Q₁ of the corresponding coil (for example, L₁) is turned on, and the winding current is circulated through the corresponding upper switch device Q₁ and upper diode d₁ and the winding. In this case, voltage applied to the corresponding coil L₁ is 0.

In addition, in mode 4 in which the inverter 10 is driven, only the lower switch device Q₂ of the corresponding coil (for example, L₁) is turned on, and the winding current is circulated through the corresponding lower switch device Q₂ and lower diode d₂ and the winding. In this case, voltage applied to the coil is 0.

The inverter 10 having the above-mentioned operation modes is driven in mode 1 to mode 4 according to an inverter control signal provided from the controlling unit 50 to sequentially activate the coils L₁, L₂, and L₃ corresponding to the corresponding phases.

For example, the controlling unit 50 provides a first inverter driving signal to the inverter 10 so as to drive a first coil L₁ corresponding to the first phase (the U phase) in mode 1 and drive second and third coils L₂ and L₃ corresponding to remaining phases (a second phase (a V phase) and a third phase (a W phase) in mode 2 to mode 4, in order to activate the first phase (the U phase).

Then, the controlling unit 50 provides a second inverter driving signal to the inverter 10 so as to drive the second coil L₂ corresponding to the second phase (the V phase) in mode 1 and drive the first and third coils L₁ and L₃ corresponding to remaining phases (the first phase (the U phase) and the third phase (the W phase) in mode 2 to mode 4, in order to activate the second phase (the V phase).

Likewise, the controlling unit 50 provides a third inverter driving signal to the inverter 10 so as to drive the third coil L₃ corresponding to the third phase (the V phase) in mode 1 and drive the first and second coils L₁ and L₂ corresponding to remaining phases (the first phase (the U phase) and the second phase (the V phase) in mode 2 to mode 4, in order to activate the third phase (the W phase).

Here, the first inverter driving signal is a signal controlling both of a first upper switch device Q₁ and a first lower switch device Q₂ to be turned on so that the winding current flows in the first coil L₁ corresponding to the first phase (the U phase) in order to drive the first coil L₁ and controlling at least one of second and third upper switch devices Q₃ and Q₅ and second and third lower switch devices Q₄ and Q₆ of the second and third coils L₂ and L₃ to be turned off so that the winding current becomes 0 in the second and third coils L₂ and L₃ corresponding to remaining second and third phases (the V and W phases) or is circulated through the corresponding switch devices Q₃ to Q₆ and diodes d₃ to d₆ and the winding.

In addition, the second inverter driving signal is a signal controlling both of the second upper switch device Q₃ and the second lower switch device Q₄ to be turned on so that the winding current flows in the second coil L₂ corresponding to the second phase (the V phase) in order to drive the second coil L₂ and controlling at least one of the first and third upper switch devices Q₁ and Q₅ and the first and third lower switch devices Q₂ and Q₆ of the second and third coils L₂ and L₃ to be turned off so that the winding current becomes 0 in the first and third coils L₁ and L₃ corresponding to remaining first and third phases (the U and W phases) or is circulated through the corresponding switch devices Q₁ and Q₂ and Q₅ and Q₆ and diodes d₁ and d₂ and d₅ and d₆ and the winding.

Likewise, the third inverter driving signal is a signal controlling both of the third upper switch device Q₅ and the third lower switch device Q₆ to be turned on so that the winding current flows in the third coil L₃ corresponding to the third phase (the W phase) in order to drive the third coil L₃ and controlling at least one of the first and second upper switch devices Q₁ and Q₃ and the first and second lower switch devices Q₂ and Q₄ of the first and second coils L₁ and L₂ to be turned off so that the winding current becomes 0 in the first and second coils L₁ and L₂ corresponding to remaining first and second phases (the U and V phases) or is circulated through the corresponding switch devices Q₁ to Q₄ and diodes d₁ to d₄ and the winding.

When a fault is generated in any one of the N phases of the main driver 11-1 of the inverter 10 operated as described above, the faulted phase is connected to the spare phase of the spare driver 13-1 through the switching unit 40.

The spare driver 13-1 of the inverter 10 as described above has an upper spare terminal s and a lower spare terminal s′ corresponding to a spare coil L_{S}, that is, a corresponding coil of the phase of the main driver 11-1 corresponding to the faulted phase among the N phases designed in the SRM 31, corresponding to the spare phase (an S phase) and includes at least one pair of spare switch devices including an upper spare switch device Q_{S1} and a lower spare switch device Q_{S2} each connected in series with the upper spare terminal s and the lower spare terminal s′.

In addition, the spare driver 13-1 of the inverter 10 includes at least one pair of spare diodes including an upper spare diode d_{S1} connected in parallel with the upper spare switch device Q_{S1} and a lower spare diode d_{S2} connected in parallel with the lower spare switch device Q_{S2} so that the winding current of the corresponding coil is circulated when any one of the pair of spare switch devices is turned off.

Here, the spare coil L_{S} is a coil corresponding to the faulted phase among the N phases of the main driver 11-1. For example, the spare core L_{S} may be the coil L₁ corresponding to the first phase (the U phase) in the case in which the fault is generated in the first phase (the U phase), be the coil L₂ corresponding to the second phase (the V phase) in the case in which the fault is generated in the second phase (the V phase), and be the coil L₃ corresponding to the third phase (the W phase) in the case in which the fault is generated in the third phase (the W phase).

The switching unit 41 includes N upper switches S₁ to S₃ each having one end connected to the upper spare terminal s and the other end connected to the respective upper terminals u, v, and w of the N coils L₁, L₂, and L₃ to perform switching so that the upper spare terminal s is connected to any one of the respective upper terminals u, v, and w of the N coils L₁, L₂, and L₃ according to the switching control signal input from the controlling unit 50 and N lower switches S₄ to S₆ each having one end connected to the lower spare terminal s′ and the other end connected to the respective lower terminals u′, v′, and w′ of the N coils L₁, L₂, and L₃ to perform switching so that the lower spare terminal s′ is connected to any one of the respective lower terminals u′, v′, and w′ of the N coils L₁, L₂, and L₃ according to the switching control signal.

The controlling unit 50 provides the switching control signal to the switching unit 41 to control the upper switches S₁ to S₃ and the lower switches S₄ to S₆ to be simultaneously switched in pair so that the upper spare terminal s and the lower spare terminal s′ of the spare driver 13-1 are connected to the upper terminals u, v, and w, and the lower terminals u′, v′, and w′ of the coils L₁, L₂, and L₃ corresponding the faulted phase of the main driver 11-1, respectively, in order to replace the faulted phase among the N phases of the main driver 11-1 with the spare phase (the S phase) of the spare driver 13-1.

For example, in the case in which a fault is generated in the first phase (the U phase) of the main driver 11-1, the switching unit 41 is switched using a first upper switch S₁ among the upper switches S₁ to S₃ of the switching unit 41 so that the upper spare terminal s of the spare driver 13-1 is connected to the upper terminal u of the coil L₁ corresponding to the first phase (the U phase) of the main driver 11-1 and at the same time, switched using a first lower switch S₄ among the lower switches S₄ to S₆ of the switching unit 41 so that the lower spare terminal s′ of the spare driver 13-1 is connected to the lower terminal u′ of the coil L₁ corresponding to the first phase (the U phase) of the main driver 11-1, according to a first switching control signal input from the controlling unit 50.

In addition, in the case in which a fault is generated in the second phase (the V phase) of the main driver 11-1, the switching unit 41 is switched using a second upper switch S₂ among the upper switches S₁ to S₃ of the switching unit 41 so that the upper spare terminal s of the spare driver 13-1 is connected to the upper terminal v of the coil L₂ corresponding to the second phase (the V phase) of the main driver 11-1 and at the same time, switched using a second lower switch S₅ among the lower switches S₄ to S₆ of the switching unit 41 so that the lower spare terminal s′ of the spare driver 13-1 is connected to the lower terminal v′ of the coil L₂ corresponding to the second phase (the V phase) of the main driver 11-1, according to a second switching control signal input from the controlling unit 50.

Likewise, in the case in which a fault is generated in the third phase (the W phase) of the main driver 11-1, the switching unit 41 is switched using a third upper switch S₃ among the upper switches S₁ to S₃ of the switching unit 41 so that the upper spare terminal s of the spare driver 13-1 is connected to the upper terminal w of the coil L₃ corresponding to the third phase (the W phase) of the main driver 11-1 and at the same time, switched using a third lower switch S₆ among the lower switches S₄ to S₆ of the switching unit 41 so that the lower spare terminal s′ of the spare driver 13-1 is connected to the lower terminal w′ of the coil L₃ corresponding to the third phase (the W phase) of the main driver 11-1, according to a third switching control signal input from the controlling unit 50.

FIG. 3 is a circuit diagram according to a second example of the motor driving apparatus shown in FIG. 1.

As shown in FIG. 3, in the present embodiment, a permanet synchronous motor (PMSM) 32 is used as the motor 30.

In the case in which the PMSM 32 is used, the main driver 11-2 of the inverter 10 includes N coils L₄, L₅, and L₆ corresponding to the N phases designed in the PMSM 32, having one connection point O at which each of the N coils L₄, L₅, and L₆ is connected to each other and common terminals u, v, and w to and from which current is input and output, and installed between the connection point O and the respective common terminals and N pairs of switch devices including upper switch devices Q₇, Q₉, and Q₁₁ and lower switch devices Q₈, Q₁₀, and Q₁₂ that are connected in series with upper and lower ends of the common terminals u, v, and w of the N coils L₄, L₅, and L₆, respectively.

The main driver 11-2 of the inverter 10 of the PMSM 32 configured as described above sequentially activate the N coils L₄, L₅, and L₆ corresponding to the N phases so that a positive torque is generated in the rotor positioned at the inner side of the stator of the PMSM 32 to thereby rotate.

To this end, the inverter 10 according to the present embodiment may have two modes (mode 1 and mode 2).

In mode 1 in which the inverter 10 is driven, both of an upper switch device Q₇ and a lower switch device Q₁₀ or Q₁₂ corresponding to a coil L₄ corresponding to a corresponding phase (for example, a first phase (a U phase)) that is intended to be activated are turned on. Therefore, the entire source power supply voltage Vs is applied to the corresponding coil L₄, such that the winding current flows therein.

Next, in mode 2 in which the inverter 10 is driven, any one or both of the upper switch device Q₇ and the lower switch device Q₁₀ or Q₁₂ corresponding to a coil L₄ corresponding to a phase (for example, a first phase (a U phase)) that is not intended to be activated may be turned off. Therefore, the current does not flow in the corresponding coil L₄.

The inverter 10 having the above-mentioned operation modes is driven in mode 1 and mode 2 according to an inverter control signal provided from the controlling unit 50 to sequentially activate the coils L₄, L₅, and L₆ corresponding to the corresponding phases.

For example, the controlling unit 50 provides a fourth inverter driving signal to the inverter 10 so as to drive a fourth coil L₄ corresponding to the first phase (the U phase) in mode 1 and drive fifth and sixth coils L₅ and L₆ corresponding to remaining phases (a second phase (a V phase) and a third phase (a W phase) in mode 2, in order to activate the first phase (the U phase).

Then, the controlling unit 50 provides a fifth inverter driving signal to the inverter 10 so as to drive the fifth coil L₅ corresponding to the second phase (the V phase) in mode 1 and drive the fourth and sixth coils L₄ and L₆ corresponding to remaining phases (the first phase (the U phase) and the third phase (the W phase) in mode 2, in order to activate the second phase (the V phase).

Likewise, the controlling unit 50 provides a sixth inverter driving signal to the inverter 10 so as to drive the sixth coil L₆ corresponding to the third phase (the W phase) in mode 1 and drive the fourth and fifth coils L₄ and L₅ corresponding to remaining phases (the first phase (the U phase) and the second phase (the V phase) in mode 2, in order to activate the third phase (the W phase).

Here, the fourth inverter driving signal is a signal controlling both of a seventh upper switch device Q₇ and a tenth lower switch device Q₁₀ to be turned on or both of the seventh upper switch device Q₇ and a twelfth lower switch device Q₁₂ to be turned on so that the winding current flows in the fourth coil L₄ corresponding to the first phase (the U phase) in order to drive the fourth coil L₄, and controlling any one or both of a ninth upper switch device Q₉ and an eighth lower switch device Q_{g} corresponding to the fifth coil L₅ to be turned off or any one or both of the ninth upper switch device Q₉ and the twelfth lower switch device Q₁₂ corresponding to the fifth coil L₅ to be turned off and controlling any one or both of an eleventh upper switch device Q₁₁ and the eighth lower switch device Q₈ corresponding to the sixth coil L₆ to be turned off or any one or both of the eleventh upper switch device Q₁₁ and the tenth lower switch device Q₁₀ corresponding to the sixth coil L₆ to be turned off, in order not to drive the fifth and sixth coils L₅ and L₆ corresponding to remaining second and third phases (the V and W phases).

In addition, the fifth inverter driving signal is a signal controlling both of the ninth upper switch device Q₉ and the eighth lower switch device Q₈ to be turned on or both of the ninth upper switch device Q₉ and the twelfth lower switch device Q₁₂ to be turned on so that the winding current flows in the fifth coil L₅ corresponding to the second phase (the V phase) in order to drive the fifth coil L₅, and controlling any one or both of the seventh upper switch device Q₇ and the tenth lower switch device Q₁₀ corresponding to the fourth coil L₄ to be turned off or any one or both of the seventh upper switch device Q₇ and the twelfth lower switch device Q₁₂ corresponding to the fourth coil L₄ to be turned off and controlling any one or both of the eleventh upper switch device Q₁₁ and the eighth lower switch device Q₈ corresponding to the sixth coil L₆ to be turned off or any one or both of the eleventh upper switch device Q₁₁ and the tenth lower switch device Q₁₀ corresponding to the sixth coil L₆ to be turned off, in order not to drive the fourth and sixth coils L₄ and L₆ corresponding to remaining first and third phases (the U and W phases).

Likewise, the sixth inverter driving signal is a signal controlling both of the eleventh upper switch device Q₁₁ and the eight lower switch device Q₈ corresponding to the sixth coil L₆ to be turned on or both of the eleventh upper switch device Q₁₁ and the tenth lower switch device Q₁₀ corresponding to the sixth coil L₆ to be turned on so that the winding current flows in the sixth coil L₆ corresponding to the third phase (the W phase) in order to drive the sixth coil L₆, and controlling any one or both of the seventh upper switch device Q₇ and the tenth lower switch device Q₁₀ corresponding to the fourth coil L₄ to be turned off or any one or both of the seventh upper switch device Q₇ and the eleventh lower switch device Q₁₂ corresponding to the fourth coil L₄ to be turned off and controlling any one or both of the ninth upper switch device Q₉ and the eighth lower switch device Q₈ corresponding to the fifth coil L₅ to be turned off or any one or both of the ninth upper switch device Q₉ and the twelfth lower switch device Q₁₂ corresponding to the fifth coil L₅ to be turned off and, in order not to drive the fourth and fifth coils L₄ and L₅ corresponding to remaining first and second phases (the U and V phases).

When a fault is generated in any one of the N phases of the main driver 11-2 of the inverter 10 operated as described above, the faulted phase is connected to the spare phase of the spare driver 13-2 through the switching unit 42.

The spare driver 13-2 of the inverter 10 as described above has a common spare terminal s corresponding to a spare coil L_{S} (not shown), that is, a corresponding coil of the phase of the main driver 11-2 corresponding to the faulted phase among the N phases designed in the PMSM 32, corresponding to the spare phase (the S phase) and includes at least one pair of spare switch devices including an upper spare switch device Q_{S3} and a lower spare switch device Q_{S4} each connected in series with upper and lower ends of the common spare terminal s.

Here, the spare coil L_{S} (not shown) is a coil corresponding to the faulted phase among the N phases of the main driver 11-2. For example, the spare core L_{S} may be the coil L₄ corresponding to the first phase (the U phase) in the case in which the fault is generated in the first phase (the U phase), be the coil L₅ corresponding to the second phase (the V phase) in the case in which the fault is generated in the second phase (the V phase), and be the coil L₆ corresponding to the third phase (the W phase) in the case in which the fault is generated in the third phase (the W phase).

The switching unit 42 includes N switches S₇ to S₉ each having one end connected to the common spare terminal s and the other end connected to each of the common terminals u, v, and w of the N coils L₄, L₅, and L₆ to perform switching so that the common spare terminal s is connected to any one of the common terminals of the N coils according to the switching control signal input from the controlling unit 50.

The controlling unit 50 provides the switching control signal to the switching unit 42 to control the N switches S₇ to S₉ to be switched so that the common spare terminal s of the spare driver 13-2 are connected to the corresponding terminal of the fault coil among the common terminals u, v, and w of the coils L₄, L₅, and L₆ corresponding to the N phases of the main driver 11-2, in order to replace the faulted phase among the N phases of the main driver 11-2 with the spare phase (the S phase) of the spare driver 13-2.

For example, in the case in which the fault is generated in the first phase (the U phase) of the main driver 11-2, the switching unit 42 is switched using a seventh switch S₇ among the N switches S₇ to S₉ of the switching unit 42 so that the common spare terminal s of the spare driver 13-2 is connected to the common terminal u of the first phase (the U phase) of the main driver 11-2, according to a fourth switching control signal input from the controlling unit 50.

Further, in the case in which the fault is generated in the second phase (the V phase) of the main driver 11-2, the switching unit 42 is switched using an eighth switch S₈ among the N switches S₇ to S₉ of the switching unit 42 so that the common spare terminal s of the spare driver 13-2 is connected to the common terminal v of the second phase (the V phase) of the main driver 11-2, according to a fifth switching control signal input from the controlling unit 50.

Likewise, in the case in which the fault is generated in the third phase (the W phase) of the main driver 11-2, the switching unit 42 is switched using a ninth switch S₉ among the N switches S₇ to S₉ of the switching unit 42 so that the common spare terminal s of the spare driver 13-2 is connected to the common terminal w of the third phase (the W phase) of the main driver 11-2, according to a sixth switching control signal input from the controlling unit 50.

FIG. 4 is a flow chart showing a motor driving method according to the preferred embodiment of the present invention; and FIG. 5 is a partial detailed flow chart of the motor driving method shown in FIG. 4.

Referring to FIG. 5, in the motor driving method according to the preferred embodiment of the present invention, first, the controlling unit 50 provides an inverter driving signal to the main driver 11 of the inverter 10 to perform a control to sequentially apply current to corresponding coils of the main driver 11 of the inverter 10 corresponding to corresponding phases so as to sequentially activate N phases designed in the motor 30 (S 100).

Then, output signals are detected from the sequentially activated N phases (S200), and whether or not a fault is generated in each phase is determined from the detected output signals of the N phases (S300). In step (S300), whether or not the fault is generated in each phase is determined through steps shown in FIG. 5.

Specifically, the controlling unit 50 determines whether the output signal, that is, detected current (I_{U}), of the first phase (the U phase) detected from the detecting unit 20 is a set value (A) (for example, I_{U}=0) (S310).

In the case in which it is determined in step (S310) that the detected current (I_{U}) of the first phase (the U phase) is not the set value (A) (for example, I_{U}=0), the controlling unit 50 determines whether the output signal, that is, detected current (I_{V}), of the second phase (the V phase) is a set value (A) (for example, I_{V}=0) (S320).

In the case in which it is determined in step (S320) that the detected current (I_{V}) of the second phase (the V phase) is not the set value (A) (for example, I_{V}=0), the controlling unit 50 determines whether the output signal, that is, detected current (I_{W}), of the third phase (the W phase) is a set value (A) (for example, I_{W}=0) (S330).

In the case in which it is determined in step (S330) that the detected current (I_{W}) of the third phase (the W phase) is not the set value (A) (for example, I_{W}=0), the controlling unit 50 determines that all of the N phases designed in the motor 30 are normal to normally operate the motor 30 using the main driver 11 of the inverter 10 (S340).

Meanwhile, in the case in which it is determined in step (S310) that the detected current (I_{U}) of the first phase (the U phase) is the set value (A) (for example, I_{U}=0), the controlling unit 50 counts a waiting time (I_{U}Count) (S312), waits for a set time (B) (for example, 20 seconds) (I_{U}Count=20) (S314), and then determines whether a re-output signal, that is, re-detected current (I_{uCount}), of the first phase (the U phase) is a set value (A) (I_{uCount}=0) (S316).

In the case in which it is determined in step (S316) that the re-detected current (I_{uCount}) of the first phase (the U phase) is the set value (A) (I_{uCount}=0), the controlling unit 50 determines that the fault is generated in the first phase (the U phase) (S318), and in the case in which it is determined in step (S316) that the re-detected current (I_{uCount}) of the first phase (the U phase) is not the set value (A) (I_{uCount}), a process is returned to step (S320), such that the following steps are repeated.

In addition, in the case in which it is determined in step (S320) that the detected current (I_{V}) of the second phase (the V phase) is the set value (A) (for example, I_{V}=0), the controlling unit 50 counts a waiting time (I_{V}Count) (S322), waits for a set time (B) (for example, 20 seconds) (I_{V}Count=20) (S324), and then determines whether a re-output signal, that is, re-detected current (I_{vCount}), of the second phase (the V phase) is a set value (A) (I_{vCount}) (S326).

In the case in which it is determined in step (S326) that the re-detected current (I_{vCount}) of the second phase (the V phase) is the set value (A) (I_{vCount}=0), the controlling unit 50 determines that the fault is generated in the second phase (the V phase) (S328), and in the case in which it is determined in step (S326) that the re-detected current (I_{vCount}) of the second phase (the V phase) is not the set value (A) (I_{vCount}=0), the process is returned to step (S330), such that the following steps are repeated.

Likewise, in the case in which it is determined in step (S330) that the detected current (I_{W}) of the third phase (the W phase) is the set value (A) (for example, I_{W}=0), the controlling unit 50 counts a waiting time (I_{W}Count) (S332), waits for a set time (B) (for example, 20 seconds) (I_{W}Count=20) (S334), and then determines whether a re-output signal, that is, re-detected current (I_{wCount}), of the third phase (the W phase) is a set value (A) (I_{wCount}=0) (S336).

In the case in which it is determined in step (S336) that the re-detected current (I_{wCount}) of the third phase (the W phase) is the set value (A) (I_{wCount}), the controlling unit 50 determines that the fault is generated in the third phase (the W phase) (S338), and in the case in which it is determined in step (S336) that the re-detected current (I_{wCount}) of the third phase (the W phase) is not the set value (A) (I_{wCount}=0), the process is returned to step (S310), such that the following steps are repeated.

As described above, when the faulted phase among the N phases is detected in step (S300), the controlling unit 50 provides the switching control signal to the switching unit 40 to perform a control so as to replace a corresponding coil of the main driver 11 of the inverter 10 corresponding to the faulted phase among the N phases designed in the motor 30 with spare phase (the S phase) of the spare driver 13 of the inverter 10 (S400).

Specifically, as shown in FIG. 5, in the case in which the controlling unit 50 determines in step (S318) that the fault is generated in the first phase (the U phase) among the N phases designed in the motor 30, the controlling unit 50 provides the first switching control signal to the switching unit 40 to switch the switching unit 40 so that the corresponding coil of the main driver 11 of the inverter 10 corresponding to the first phase (the U phase) is connected to the spare phase (the S phase) of the spare driver 13 of the inverter 10 (S410).

Further, in the case in which the controlling unit 50 determines in step (S328) that the fault is generated in the second phase (the V phase) among the N phases designed in the motor 30, the controlling unit 50 provides the second switching control signal to the switching unit 40 to switch the switching unit 40 so that the corresponding coil of the main driver 11 of the inverter 10 corresponding to the second phase (the V phase) is connected to the spare phase (the S phase) of the spare driver 13 of the inverter 10 (S420).

Likewise, in the case in which the controlling unit 50 determines in step (S338) that the fault is generated in the third phase (the W phase) among the N phases designed in the motor 30, the controlling unit 50 provides the third switching control signal to the switching unit 40 to switch the switching unit 40 so that the corresponding coil of the main driver 11 of the inverter 10 corresponding to the third phase (the W phase) is connected to the spare phase (the S phase) of the spare driver 13 of the inverter 10 (S430).

As described above, with the motor driving apparatus and method according to the preferred embodiment of the present invention, even in the case in which the fault is generated in any one of the N phases designed in the motor 30, the faulted phase is replaced with the spare phase, thereby making it possible to normally operate the motor 30 with the N phases rather than N−1 phases.

Therefore, the motor 30 is driven without replacement of the inverter 10 driving the motor 30 and a change in originally design phases, such that a cost may be reduced and the motor 30 may be efficiently and stably driven.

Although the case in which the number of phases driving the motor 30 is 3 has been described in the preferred embodiment of the present invention, the present invention may also be applied to a multi-phase motor as well as a single-phase motor.

As set forth above, according to the preferred embodiments of the present invention, the spare phase is installed in the inverter driven with the N phases, thereby making it possible to drive the motor by replacing the faulted phase with the spare phase when the fault is generated in any one of the N phases.

Particularly, since the motor may be driven without replacing the inverter when the fault is generated in any one of the N phases, a cost may be reduced, and since the motor may be driven without a change in the number of phases, the motor may be efficiently and stably driven.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A motor driving apparatus comprising:
an inverter including a main driver sequentially activating N phases of a motor and a spare driver activating a spare phase substituting for a faulted phase among the activated N phases;
a detecting unit detecting the respective output signals of the N phases input from the inverter to the motor;
a switching unit performing switching so that the spare phase of the spare driver is connected to the faulted phase of the exited N phases; and
a controlling unit driving the inverter to determine whether or not a fault is generated in the phase of the main driver from the respective detected output signals of the N phases and control the switching unit so that the faulted phase is connected to the spare phase when the fault is generated in the phase.

2. The motor driving apparatus as set forth in claim 1, wherein the inverter further includes a power supply unit supplying power to the main driver and the spare drive.

3. The motor driving apparatus as set forth in claim 1, wherein the motor is a switched reluctance motor (SRM).

4. The motor driving apparatus as set forth in claim 3, wherein the main driver of the inverter includes:
N coils corresponding to the N phases designed in the motor and having upper terminals and lower terminals to and from which current is input and output;
N pairs of switch devices including upper switch devices and lower switch devices that are connected in series with the upper terminals and the lower terminals of the N coils, respectively; and
N pairs of diodes including upper diodes each connected in parallel with the upper switch devices and lower diodes each connected in parallel with the lower switch devices so that winding current of a corresponding coil is circulated when any one of the N pairs of switch devices is turned off.

5. The motor driving apparatus as set forth in claim 4, wherein the spare driver of the inverter includes:
an upper spare terminal and a lower spare terminal corresponding to a corresponding coil of the phase of the main driver corresponding to the faulted phase among the N phases designed in the motor;
at least one pair of spare switch devices including an upper spare switch device and a lower spare switch device each connected in series with the upper spare terminal and the lower spare terminal; and
at least one pair of spare diodes including an upper spare diode connected in parallel with the upper spare switch device and a lower spare diode connected in parallel with the lower spare switch device so that the winding current of the corresponding coil is circulated when any one of the at least one pair of spare switch devices is turned off.

6. The motor driving apparatus as set forth in claim 5, wherein the switching unit includes:
N upper switches each having one end connected to the upper spare terminal and the other end connected to the respective upper terminals of the N coils to perform switching so that the upper spare terminal is connected to any one of the upper terminals of the N coils according to a switching control signal input from the controlling unit; and
N lower switches each having one end connected to the lower spare terminal and the other end connected to the respective lower terminals of the N coils to perform switching so that the lower spare terminal is connected to any one of the lower terminals of the N coils according to the switching control signal.

7. The motor driving apparatus as set forth in claim 6, wherein the controlling unit controls the corresponding upper switch so that the upper spare terminal of the spare driver is connected to the upper terminals of the corresponding coils of the main driver and at the same time, controls the corresponding lower switch so that the lower spare terminal of the spare driver is connected to the lower terminals of the corresponding coils of the main driver, in order to connect the corresponding coil of the main driver corresponding to the faulted phase among the N phases to the spare driver.

8. The motor driving apparatus as set forth in claim 1, wherein the motor is a permanet synchronous motor (PMSM).

9. The motor driving apparatus as set forth in claim 8, wherein the main driver of the inverter includes:
N coils corresponding to the N phases designed in the motor, having one connection point at which each of the N coils is connected to each other and common terminals to and from which current is input and output, and installed between the connection point and the respective common terminals; and
N pairs of switch devices including upper switch devices and lower switch devices that are connected in series with upper and lower ends of the common terminals of the N coils.

10. The motor driving apparatus as set forth in claim 9, wherein the spare driver of the inverter includes:
a common spare terminal corresponding to a corresponding coil of the phase of the main driver corresponding to the faulted phase among the N phases designed in the motor; and
at least one pair of spare switch devices including an upper spare switch device and a lower spare switch device each connected in series with upper and lower ends of the common spare terminal.

11. The motor driving apparatus as set forth in claim 10, wherein the switching unit includes N switches each having one end connected to the common spare terminal and the other end connected to each of the common terminals of the N coils to perform switching so that the common spare terminal is connected to any one of the common terminals of the N coils according to a switching control signal input from the controlling unit.

12. The motor driving apparatus as set forth in claim 11, wherein the controlling unit controls the corresponding switch so that the common spare terminal of the spare driver is connected to the common terminals of the corresponding coils of the main driver, in order to connect the corresponding coil of the main driver corresponding to the faulted phase among the N phases to the spare driver.

13. The motor driving apparatus as set forth in claim 1, wherein the detecting unit is a current sensor, a voltage sensor, a phase position sensor, or a combination thereof.

14. The motor driving apparatus as set forth in claim 1, wherein the detected signal is a current signal, a voltage signal, a phase position signal, or a combination thereof.

15. A motor driving method comprising:
(A) driving a main driver of an inverter to sequentially activate N phases designed in a motor;
(B) detecting, in a detecting unit, the respective output signals of the activated N phases of the main driver input from the inverter to the motor; and
(C) determining, in a controlling unit, whether or not a fault is generated in the phase of the main driver from the respective detected output signals of the N phases and performing switching so that the faulted phase is connected to a spare driver of the inverter substituting for the faulted phase when the fault is generated in the phase.

16. The motor driving method as set forth in claim 15, wherein step (C) includes:
(C1) determining, in the controlling unit, whether or not the fault is generated in the phase of the main driver from the respective detected output signals of the N phases; and
(C2) performing, in the controlling unit, switching so that the faulted phase of the main driver is connected to a spare phase of the spare driver substituting for the faulted phase when the fault is generated in the phase of the main driver.

17. The motor driving method as set forth in claim 16, wherein step (C1) includes:
(C1-1) determining, in the controlling unit, whether the respective detected output signals of the N phases are a set value (A);
(C1-2) determining that the fault is generated in the corresponding phase in the case in which the respective detected output signals of the N phases are the set value A.

18. The motor driving method as set forth in claim 17, wherein the respective output signals of the N phases are current signals, and the set value A is 0 mA.

19. The motor driving method as set forth in claim 17, wherein step (C1) further includes, after step (C1-1),
(C1-3) waiting for a set time (B) and then re-detecting the respective re-output signals of the N phases in the case in which the respective output signals of the N phases are the set value (A);
(C1-4) determining whether the respective re-detected re-output signals of the N phases are the set value (A); and
(C1-5) determining that the fault is generated in a corresponding phase in the case in which the respective re-detected re-output signals of the N phases are the set value (A).

20. The motor driving method as set forth in claim 19, wherein the respective output signals and re-output signals of the N phases are current signals, the set value (A) is 0 mA, and the set time (B) is 15 to 25 seconds.

21. The motor driving method as set forth in claim 17, wherein step (C1-1) includes determining that a corresponding phase is normal in the case in which the respective output signals of the N phases are not the set value (A).

22. The motor driving method as set forth in claim 19, wherein step (C1-4) includes determining that a corresponding phase is normal in the case in which the respective re-detected signals of the N phases are not the set value (A).

23. The motor driving method as set forth in claim 16, wherein step (C2) includes:
(C2-1) providing, in the controlling unit, a switching control signal to a switching unit configured to connect between a terminal of a coil corresponding to the faulted phase and a spare terminal corresponding to the spare phase of the spare driver when the fault is generated in the phase of the main driver; and
(C2-2) performing, in the switching unit, switching so that the terminal of the coil corresponding to the faulted phase of the main driver is connected to the spare terminal according to the switching control signal provided from the controlling unit.
